(19) United States
(12) Patent Application Publication
(10) Pub. No.: US 2014/0254543 A1
(43) Pub. Date: Sep. 11, 2014

(54) METHOD FOR TRANSMITTING DATA BETWEEN A MOBILE TERMINAL AND AT LEAST ONE STATIONARY DATA NETWORK, MOBILE TERMINAL AND MOTOR VEHICLE HAVING A MOBILE TERMINAL

(71) Applicants: Lars Engelhard, Ilmendorf (DE); Stefanie Engelhard, Ilmendorf (DE)

(72) Inventors: Lars Engelhard, Ilmendorf (DE); Stefanie Engelhard, Ilmendorf (DE)

(73) Assignee: Audi AG, Ingolstadt (DE)

(21) Appl. No.: 14/358,296

(22) PCT Filed: Sep. 14, 2012
(86) PCT No.: PCT/EP2012/003861

§ 371 Date: May 15, 2014

(30) Foreign Application Priority Data
Nov. 16, 2011 (DE) 10 2011 118 706.9

(51) Int. Cl. H04W 64/00; H04W 72/12

(52) U.S. Cl. CPC H04W 64/006; H04W 72/1226
USPC 370/329

(57) ABSTRACT

A wireless interface provides a location-dependent transmission bandwidth for mobile access to a stationary data network. To this end, historical values relating to wireless interface parameters for a plurality of locations and for predetermined times are stored in a geo-database. Expected values for future data transmissions are ascertained from stored values. At the outset, a probable route for movement and an estimated arrival time of the mobile terminal at a location along the route are ascertained. The expected transmission bandwidth at the location is then ascertained based on the geo-database. During the transmission of data, at least one data transmission is regulated in accordance with the transmission bandwidths expected to be available along the route.

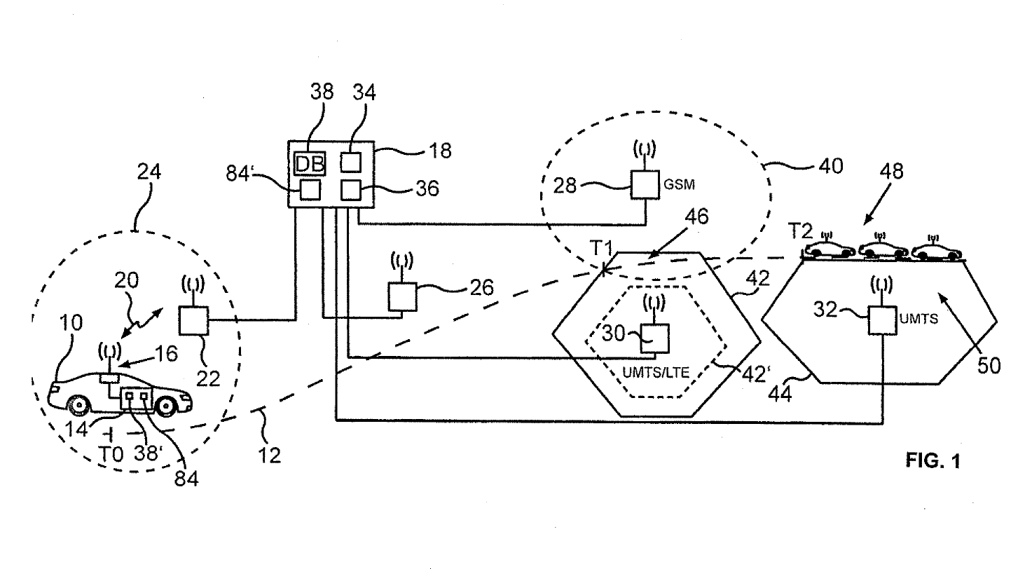

The invention relates to a method for transmitting data between a mobile terminal and at least one stationary data network via at least one wireless interface. The invention also relates to a mobile terminal with a mobile communications module for transmitting data via at least one wireless interface and a control device for controlling the transmission. The invention furthermore relates to a motor vehicle with such a mobile terminal. A method and a motor vehicle of the aforedescribed type are known from U.S. 2010/0323715 A1. The invention also relates to a process for producing a geo-database, in which values relating to wireless interface parameters of at least one wireless interface are stored for a plurality of locations.

For mobile access to a stationary data network, a specific transmission bandwidth for exchanging data is provided by a wireless interface. For example, the Internet as a stationary data network can be reached via the wireless interface of the UMTS (Universal Mobile Telecommunications System) of a mobile terminal. Such mobile terminals, for example mobile phones or PDAs (PDA—Personal Digital Assistant), generally use the transmission bandwidth available at a given time for the parallel transmission of all data to be exchanged with the stationary data network, such as voice, configuration data or data of Internet services. However, the transmission bandwidth can strongly depend on the location. In addition, the transmission bandwidth may also vary at a given location over time and in particular depend on environmental parameters, such as the weather conditions or the number of mobile terminals operating simultaneously at that location. The transmission bandwidth can therefore fluctuate within a short time especially for mobile terminals in vehicles. When the available transmission bandwidth is low, severe restrictions occur due to the simultaneous and competing use of the wireless interface by different services provided by the mobile terminal.

A method is described in the above mentioned document, wherein a route of the vehicle is determined for a mobile terminal in the vehicle and it is checked whether a problem may exist with a transmission bandwidth of a wireless interface of the data network along the route. Optionally, parameter values of the wireless interface are modified by a control device of the mobile network so as to eliminate transmission problems when the vehicle passes through the problematic region. Examples of such parameter values that can be changed by the control device of the mobile network are a time for a handoff, response parameters for a multi-path fading and transmission modes. This method has the disadvantage that mobile communications network operators must equip their base stations with appropriate control devices.

It is an object of the present invention to avoid as much as possible limitations in a mobile terminal caused by movement of the mobile terminal when transmitting data over a wireless interface.

The object is attained by a method according to claim 1, a method according to claim 7, a mobile terminal according to claim 9, and a motor vehicle according to claim 10. Advantageous embodiments of the invention are recited in the dependent claims.

According to a first aspect of the invention, a method is provided for transmitting data between the mobile terminal and at least one stationary data network via at least one wireless interface. In this method, the mobile terminal does not need to rely on the base stations of the wireless interface for adjusting their wireless interface parameters, when the mobile terminal passes by and when during this time data are to be transmitted to a stationary data network. Instead, a geo-database is provided which stores historical values relating to the wireless interface parameters for a plurality of locations and for predetermined points in time. Wireless interface parameters within the context of the invention refer to information that can be used to derive a transmission bandwidth of the at least one wireless interface to the respective location. The value of the wireless interface parameter may be, for example, a measured transmission bandwidth or simply information as to whether the corresponding wireless interface can be accessed or not.

Estimated values of wireless interface parameters for future data transmissions are determined from the historical values. According to a further method step, an expected route of the mobile terminal is first determined, whereafter it is determined for at least one location along the route, when the mobile terminal is expected to arrive at that location. The estimated transmission bandwidth available at that location is then determined based on the geo-database for the at least one location along the route and the estimated time of arrival. The geo-database provides historical values that were actually observed in the past at the respective location and at the corresponding times. These values can be used to make predictions about the transmission bandwidth expected to be available at the likely time of arrival. In order smoothly exchange data with the at least one stationary data network via the at least one wireless interface, at least one data transmission between the mobile terminal and the at least one data network, i.e. at least one data exchange process, is regulated depending on the transmission bandwidth expected to be available at the different locations along the route.

This inventive method has the advantage that the wireless interface parameters need not be adapted to the requirements of the mobile terminal during the transmission of the data; instead, the mobile terminal adjusts in advance its data transmission to the given transmission bandwidth along the route. An important aspect is here the provision of the geo-database, in which the time dependence of the values for the wireless parameters is stored for different locations, so that, for example, the spatial extent of a UMTS cell (UMTS—Universal Mobile Telecommunication System) which depends on its utilization is recorded as a function of time, allowing the data transmission to be adjusted accordingly. The individual steps of the method may be performed by the mobile terminal itself or by a separate data processing device, for example one or more servers in the at least one data network. A hybrid solution is also possible, wherein parts of the procedure are carried out by different components.

The geo-database can be provided in the form of a storage medium in the mobile terminal. The geo-database may also be a data service provided for the mobile terminal by a server of the least one stationary data network.

Within the context of the invention, any strategy for determining transmission times or for throttling a transmission data rate of a data stream is generally suitable to regulate the data transmission. It is important, though, that the operation of the mobile radio interface itself remains unaffected. The method takes for granted the transmission bandwidths available at the different locations. A likely upcoming change of the available transmission bandwidth is recognized in advance by analyzing the historical values associated with the wireless interface parameters and the transmission characteristic of the mobile terminal is adjusted commensurately. This prevents competing services of the mobile terminal from blocking each other or even a disconnection. Since neither the mobile communications module of the terminal nor the wireless interface need to be influenced, the method of the invention is advantageously also independent of the technology of the mobile networks used for the transmission.

According to one embodiment of the method according to the invention, the data transmission may be regulated by transmitting ahead of time data that are needed at a later time and by storing these data in the mobile terminal. This advantageously ensures that the data are present at the time of their intended use even when only a lower transmission bandwidth is available at that time.

Similarly, the mobile terminal can also send data ahead of time. This is useful, for example, for data services, where a current position of the mobile terminal in the data network can be retrieved. Such data services typically do not work when the terminal is, for example, outside a wireless coverage area. When it is recognized that the terminal is expected to be located outside such wireless coverage area, the terminal can prematurely send position data to notify the data service of the estimated arrival time. Position information for the data service is thus also possible while the terminal cannot be reached.

According to another embodiment of the method of the invention, the transmission of data packets may be delayed. For example, low-priority data may be transmitted with a time delay so as not to interfere with higher-priority services. Another advantage is that asynchronous data services can be optimally utilized.

The data to be transmitted can also be changed in terms of their coding and/or compression. For example, in response to an expected decrease in the transmission bandwidth, the coding parameters in an audio or video stream may be adapted in order to ensure a continuous uninterrupted reproduction of the audio or video data.

According to another embodiment of the method according to the invention, in the context of a prioritization of data services, different priorities may be set for at least two data packets to regulate the transfer of data and different transmission times may be set for the two data packets based on these priorities. With the assignment of priorities for individual data packets, the data transmission can be readily regulated automatically.

Determination of the expected route does not necessarily require a user of the mobile terminal to indicate his destination and the planned route to this destination. If this information is not available, according to an embodiment of the method according to the invention, the expected route may be based on data according to at least one of the following aspects. An important indication of the expected route of the mobile terminal may already be determined based on an identity of a current user of the mobile terminal. The route may be inferred if the user of the mobile terminal has selected a user profile that indicates, for example, whether he currently uses the equipment for business or pleasure. Even a time of the day can give an indication of the expected destination. User habits may also be collected over time and used as a basis for determining the route. An indication of the likely actions of a user may also be predicted based on current or forecast weather.

The inventive method is not limited to exclusively determine the anticipated transmission bandwidth along the route based on the geo-database when it was static. Instead, environments can also be detected dynamically, i.e. time-varying and parameter-specific conditions could be included. According to one embodiment of the method of the invention, an expected load of the at least one wireless interface for a location along the route may be determined, and the expected transmission bandwidth could additionally be determined as a function of the expected load. When the at the mobile terminal is, for example, a component of a vehicle and when traffic congestion is reported along the route, it can be assumed that many drivers standing in traffic will make a call with their mobile phones to notify of people waiting. This typically results in an increased utilization of the wireless interfaces, which may be taken into account when controlling the data transmission by the mobile terminal.

The spatial database need not only contain the information about the wireless interface parameters for individual locations as a function of time. In order to plan the transmission of data more accurately in advance, a value for an environmental parameter of a specific location can also be stored in addition to the time. For example, the volume of road traffic at the time the value for the wireless interface parameters was measured may be stored. Likewise, the prevailing weather and/or the season when the value for the wireless interface parameters was measured may be stored. This information has proven to be useful when an accurate prediction of the available bandwidth along a route must be generated. An environmental parameter is generally to be understood as a variable characteristic of the location from which a bandwidth of a wireless interface available for a single mobile terminal for this location can depend.

Another aspect of the invention relates to a method for generating the aforedescribed geo-database. The method in this case has the advantage that costly test runs are not required to provide the values for the wireless interface parameters to a mobile terminal. According to the method of the invention, the current locations of a plurality of mobile terminals may be determined. Furthermore, the values for the wireless interface parameters are obtained by means of these mobile terminals. For example, a control device of a base station may for this purpose query which value the mobile terminal is measuring when transferring data of the wireless interface parameters. The obtained value is then stored together with both the respective location where the mobile terminal was located when the value was acquired and a time stamp which indicates the time the respective value was obtained,

The method for generating the geo-database can be extended without incurring significant additional expenses by storing at least one value of at least one additional environmental parameter of the respective location, especially the weather at the location at the time the value was obtained, and a measure of the volume of road traffic and the season at the time the value was obtained. Such information can be determined for a mobile terminal due to its networking with other data services usually while the data are obtained. As another example, a probability for a composition of the road traffic may be determined to identify whether more road users are traveling by bicycle. This can be determined, for example, from an average speed of each mobile terminal. The additional environmental parameters need not necessarily be detected by the mobile terminal itself. They can also be determined, as appropriate, from the particular device that compiles the geo-database.

A third aspect of the invention relates to a mobile terminal configured to exchange data with at least one stationary data network via at least one wireless interface. For this purpose, the mobile terminal includes a mobile communications module configured to exchange the data via at least one wireless interface. A control device of the mobile terminal is designed to exchange data with the at least one stationary data network depending on a transmission bandwidth of the at least one wireless interface expected to be available along a route of the mobile terminal, and to carry out an embodiment of at least one of the methods according to the invention.

Within the context of the invention, the mobile terminal according to the invention may be a mobile phone, a smart phone, a laptop or another communication device located in a mobile object. This communication unit can also be fixedly integrated in a vehicle, such as a motor vehicle. In connection with the method for generating the geo-database, the mobile terminal of the present invention may also be designed to independently determine the current connection quality and other current, transmission-specific parameters. Optionally, the terminal may determine the time and date, as is possible, for example, via a satellite system, or other wireless resources.

Exemplary embodiments of the invention will now be explained in more detail below. The figure shows a diagram of a driving situation of a vehicle 10 representing an embodiment of the motor vehicle according to the invention. The vehicle may be, for example, a passenger car. The vehicle 10 is traveling on a route 12 on which it is located at a time T0 at the location indicated in the figure.

A control device 14, which exchanges data via a mobile communications module 16 with various servers on a data network 8, for example the Internet, is located in the vehicle 10. The control device 14 may be, for example, a component of an infotainment system. The mobile communications module 16 is hereby connected with a base station 22 of a mobile communications network via a wireless link 20. The base station 22 forms a wireless interface to the mobile communications network. A range of 24 of the base station 22 is limited such that the wireless link 20 cannot be maintained on the route 12 during the entire trip. In order to be able to exchange data with the data network outside the range 24, a wireless connection to other base stations 26, 28, 30, 32 must be set up by the mobile communications module 16 at a given time, wherein the other base stations 26, 28, 30, 32 may be part of the same mobile communications network or of another mobile communications network. The control device 14 is aware of the current position of the vehicle 10. The location can be determined by using, for example, GPS, GLONASS, Galileo, or another satellite-based system or a terrestrial positioning system. Any other position determination system may also be used.

Furthermore, the current connection quality and other current transmission-specific parameters may be detected by the mobile communications module 16 and/or the control device 14. The time and date can be also detected. This may be known, for example, from information provided by the satellite system or from other sources. The control device 14 further estimates that the vehicle 10 is traveling along the route 12. The control device 14 accesses hereby data aggregated in the past that were used to statistically determine the behavior of the driver based on his habits and the characteristics of the surroundings of the vehicle 10. The following exemplary data may have been determined: a preferred route to work, shopping habits, a preferred parking space (garage, underground garage or roadside), the network quality of each wireless interface along route 12 observed in the past, the type of available mobile communications networks (for example, 2G, 3G, LTE, WLAN, EDGE, and other technologies), a network access technology available at the parking spaces (e.g., including wired connections such as LAN, Powerline-Communication PLC), available transmission bandwidths of the individual network accesses, typical travel speeds of the vehicle 10 and alternative routes driven in the past.

The data can be extended with additional information listed here as examples: To find the current route of the vehicle 10, the current location may be relied on, as well as the destination of the driver that was entered, for example, into a navigation assistant, the current date and time, the time of year, weather data (detected for example by vehicle sensors or a weather station), the current temperature, the number of occupants in the vehicle 10 or the identity of the occupants in the vehicle 10. These are only examples of the parameters that can be taken into account by the mobile terminal, the infotainment system 14 and the mobile communications module 16 in the planning of the transmission of data between the vehicle 10 and the data network 18.

In the underlying example of the figure, data from two different data sources 34, 36 of the data network 18 are to be transmitted to the vehicle 10. The data source 34 may be, for example, a streaming server, which can be used to receive music audio data from the data network 18, which can then be played back in the vehicle 10 via an audio system. The data from the data source 34 must therefore be downloaded continuously without prolonged interruption. The data source 36 may be, for example, an update server providing updated operating software for the control device 14 and other systems of the vehicle 10. The data from the data source 36 may be downloaded piecemeal, with interruptions.

The control device 14 now determines for the travel on the route 12 whether a continuous data stream from the data source 34 to the vehicle 10 can be ensured and whether concurrently updated software can be downloaded from the data source 36. To meet these requirements regarding the availability of the data from the data sources 34, 36 in the vehicle 10, a schedule is created by the controller 14, according to which individual data packets are retrieved from the data sources 34, 36. This schedule may also provide for downloading data packets in advance and storing them in a cache before they are actually needed in the vehicle 10. It can also be determined with the schedule when the mobile module 16 changes between two different base stations 22, 26 to 32 and whether the download of individual data packets will be delayed in order to compensate accordingly for an expected likely deterioration of transmission quality.

For creating the schedule, the control device 14 recalls from a database 38 information about which base station 22, 26, 28, 30, 32 is located along the route 12. The database 38 may be provided by a server of the data network 18. The information may also be located entirely or partially in a local database 38′ in the vehicle 10 or in the mobile terminal itself, e.g. in the control device 14. In addition to the locations of the base stations 22, 26 to 32, information about the ranges 24, 40, 42, 44 of the individual base stations 22, 28, 30, 32 is stored in the database 38. This information represents wireless interface parameters of the wireless interfaces formed by the base stations 26, 28, 30, 32.

The control device 14 determines based on the data that a connection to the base station 30 could be set up in a section 46 of the route 12, wherein the base station 30 represents a wireless interface with a typically high transmission bandwidth. For example, the wireless interface formed by the base station 30 may be a wireless interface of a UMTS or LTE mobile communications network. The control device 14 calculates based on the parameters acquired by the control device 14 and the mobile communications module 16, that the vehicle 10 is expected to arrive at a time T1 at the route section 46. The control device 14 detects based on the data from the database 38 that at that time the range of the base station 30 has usually decreased to a range 42′. A reason for such a decrease may be, for example, typical rush-hour traffic in the route section 46 at the time T1. With the decreased range 42′, the base station 30 in the route section 46 cannot be accessed by the vehicle 10. For scheduling the data transmission from the data sources 34 and 36, the controller 14 therefore assumes that the mobile communications module 16 will automatically switch to the base station 28 upon reaching the route section 46, which may for example be part of a GSM mobile communications network and which therefore has insufficient bandwidth for the simultaneous transmission of data. According to the schedule, only the data to be downloaded continuously from the data source 34, such as the music data, should therefore be obtained from the base station 28 in the route section 46. The downloading of the data from the data source 36 can therefore be interrupted during this period. In addition, the bandwidth required for the transmission of the music data may be reduced. If the audio data stream is currently transmitted with, for example, 256 Kbits and the transmission bandwidth of the wireless interface of the base station 28 in the section 46 is too low for this purpose, for example a signal may be sent to the data source 34 to reduce the audio quality, so that only a bandwidth of e.g. 128 Kbit/s is required.

The control device 14 also monitors information about the current traffic conditions along the route 12. The control device 14 may, for example, receive suitable traffic data from the data network 18 over a digital broadcast. The control device 14 is thus notified of traffic congestion 48 in a route section 50. The controller 14 can, for example, determine based on a numerical model that the traffic congestion 48 will not yet be resolved when the vehicle 10 arrives at a time T2 in the route section 50. The controller 14 can also determine from the numerical model that a base station 32 will be particularly severely loaded in the route section 50 in the event that traffic congestion has formed there. If the base station 32 is, for example, a UMTS base station, this means that only a low bandwidth will be available for individual mobile subscribers. This is also taken into account by the control device 14 when scheduling the transmission of the data of the data sources 34, 36.

The current position of the mobile terminal, i.e. in this case of the entire vehicle 10, may be recalled from the data network 18 via a data service. For example, the position of a parked vehicle 10 can be retrieved later by a query. In the example, the control device 14 detects that the location at the end of the route 12, where the vehicle 10 is expected to be parked, is outside a wireless coverage area. Therefore, the control device 14 provides during the trip information to the data service indicating where the vehicle 10 is expected to be parked at the end of the trip and when the vehicle 10 will arrive at that location. The data service can then still find the vehicle 10 even after the vehicle can no longer be reached by the data service via wireless communication in order to query its current position.

In the above example and also in the examples described below, it is assumed that the steps relating to the method of the invention are executed by a data processing device 84 of the mobile terminal. According to another embodiment, some or all of these steps may, however, also be carried out by a separate data processing device 84′, which may be located for example in the data network 18.

It will now be explained with reference to other examples, how by scheduling the transmission timing of individual data packets, the data transmission can be adapted to the varying transmission bandwidth during movement of the vehicle when transmitting the data between a vehicle and a stationary data network.

In a first example, a user is driving home from his workplace in his passenger car, in which a mobile terminal is integrated. During the trip, a software update for a non-safety-critical control device of the passenger car is announced to the mobile terminal by a distributor, i.e. a respective update server in the data network, as now being available. The driver listens to Internet radio while driving, requiring that continuous data be downloaded from the Internet. This data flow should not be interrupted, since otherwise the music playing in the passenger car would be interrupted. The mobile terminal continuously detects a current position of the passenger car along the route home.

According to a first variant of the example, the transmission bandwidth along the route home may be so high that the driver can continue to listen to Internet radio while at the same time the software update can be downloaded. The mobile terminal queries the geo-database as to which mobile interfaces along the route home can be accessed. The mobile terminal furthermore reads from the geo-database for the individual mobile interfaces the transmission bandwidths attainable via the individual mobile interfaces as a function of time. The mobile terminal calculates for individual points in time, where it will be located on the route home and recognizes that the transmission bandwidth is expected to be high enough at any given time to download the data stream via the Internet radio and to update the software. In other words, the mobile terminal detects that the Internet is expected to be accessible along the entire route home with a transmission bandwidth that does not fall below a certain minimum value. Therefore, the mobile terminal simultaneously downloads the data stream for Internet radio and updates the software.

According to a second variant of this example, the transmission bandwidth is so high that the driver can simultaneously download the Internet radio and the software update. The terminal also determines that strong fluctuations, especially severe drops in the transmission bandwidth can be expected on the way home, as determined from the route and the data contained in the geo-database. The data clearly show for several locations along the route that at an estimated arrival time the transmission bandwidth will be much lower than necessary for downloading both the data stream for the Internet radio and updating the software. The terminal must therefore decide whether to download the software update, albeit with a very low data rate, so as not to interrupt the Internet radio, or to delay the software update. For example, the transmission bandwidth may be greater and more reliable at the usual parking space of the motor vehicle. The download of the update could then be delayed until the arrival at this parking space. The decision must be made to never interrupt the Internet radio, since otherwise the user would be dissatisfied.

According to a third version of this example, the terminal is in a coverage area of a mobile network with a low data rate, for example, a 2G network. The device then delays the software update until enough data transmission bandwidth is available. In this case, the terminal may use the previously collected data about the habits of the user, the vehicle and the likely routes to select a better time for the software update.

Another example shows how habits of a user of a mobile terminal and in addition also weather data can also be used for scheduling the transmission of data. According to this example, a user drives back home from his workplace in his motor vehicle, in which a terminal is integrated. No destination is specified in the navigation system. The terminal knows the position at which it is located along the route home. According to a first version of this example, the terminal detects that is the summer and the temperature is above 30° C. The terminal predicts from the learned user behavior that the driver will most likely drive to the lake near his home. The terminal therefore assumes this as a destination of the route and determines accordingly the transmission bandwidths available along this route.

According to a second version of the example, the mobile terminal recognizes again that it is summer, but that it is raining. The terminal now predicts from the user's behavior that the driver will go directly to his apartment. The device then bases a calculation of the most likely route on this destination. The likely future network coverage can then be inferred again from the predicted destination. The expected data transmission services can thus be prioritized and, if necessary, delayed.

It will now be explained in form of another example how to even more accurate predictions of an available transmission bandwidth along a route can be obtained, when the values for each wireless interface parameters of the different locations are stored in a geo-database not only as a function of predetermined points in time, but also of other environmental parameters of the locations. According to this example, a user again drives home from his workplace in a motor vehicle with an integrated terminal. The destination is assumed to be known to the mobile terminal. The values for the wireless interface parameters dependent on the season are accessible in the geo-database and available in this form to the mobile terminal. For example, it is further assumed that it is summer. According to a first version of the example, the mobile terminal accesses a subset of the collected data (network availability, type of network, and the like), which takes into account the traffic situation during the respective season, in this case summer. For example, it is conceivable that during the summer more road users travel by bicycle than during the winter. According to a second version of the example, it will be assumed that it is raining. The mobile terminal then accesses a subset of the geo-data, which takes into account the traffic situation at the respective season (summer) when it rains. It would be conceivable, for example, that the geo-data for the mobile terminal show that the traffic situation is more similar to wintertime than to summertime, since most likely more people are traveling by car than by bicycle. Predictions can then be made by the mobile terminal regarding the network quality and the transmission bandwidth, wherein fluctuations are taken into account, such as a breathing cell in a UMTS mobile radio system.

In conjunction with the generation of a geo-database with a design that can be used by the mobile terminals in the manner described above, data may be stored by way of parameters of an actual user of the mobile terminal, wherein these data are evaluated and collected either in the terminal itself and/or at a central data processing unit. The data can hereby be correlated with other user data, i.e. the data can also be averaged across multiple users and multiple devices. For example, the network coverage of a route can be determined at different times using several vehicles having suitable mobile terminals. Through the use of multiple mobile terminals for capturing the geo-data, an effect referred to as swarm intelligence can be achieved: for example, when several vehicles drive through a mobile radio cell of a UMTS system at different times of the day, a breathing cell and other temporary phenomena (shading, multipath propagation) can be detected when the geo-data are compiled.

The resulting aggregated data can be processed on the terminal and/or after transmission to one or multiple data processing units. To ensure data privacy, the data sets can be made anonymous. Prior processing of data in the terminal is feasible so as to process all protected information before transmission and to only transmit results; if desired, wherein the results are then again made anonymous. The terminal then determines the most likely destination of a current trip based on these data (geo-data), i.e. through evaluation of historical user-specific and device-specific data as well as of actual parameters. Possible destinations (optionally weighted with statistical probability) then allow optimization of the data links in the aforedescribed manner.

The example demonstrates how the connectivity of each moving terminal connected via air interfaces to the Internet or to future global networks can be improved. Fluctuations over time, a temporary network expansion and technology enhancements can be recognized based on the employed geo-data with temporal linkage. With the generic use, the method is decoupled from the available radio communication technologies and transmission techniques and can therefore be readily adapted also to future technologies. In summary, by gathering the geo-data and using them in the mobile terminals, the network coverage can be independently learned and the connectivity of the mobile terminals can be optimized.

1-10. (canceled)

11. A method for transmitting data between a mobile terminal and at least one stationary data network via at least one wireless interface, the method comprising:
storing in a geo-database historical values relating to wireless interface parameters for a plurality of locations and for predetermined points in time;
deriving from the historical values a transmission bandwidth of the at least one wireless interface at the plurality of locations;
determining an expected route of the mobile terminal;
determining an estimated time of arrival of the mobile terminal at at least one location along the route;
determining an expected transmission bandwidth at the at least one location along the route for the estimated time of arrival based on the geo-database; and
transmitting the data between the mobile terminal and the at least one stationary data network via the at least one wireless interface and regulating at least one data transmission in dependence on the expected transmission bandwidth available along the route.

12. The method of claim 11, wherein the at least one data transmission is regulated by performing at least one of the following measures: data needed at a later time will be transmitted ahead of time and stored in the mobile terminal; the mobile terminal sends data out ahead of time; a transmission of data packets is delayed; coding or compression of data packets is adapted.

13. The method of claim 11, wherein regulating the least one data transmission comprises defining different priorities for at least two data packets and setting different transmission times for the two data packets as a function of the priorities.

14. The method of claim 11, wherein the expected route is determined from data relating to at least one of the following aspects: an identity of a user of the mobile terminal; a user profile selected by the user; a current time; user habits; current weather or forecast weather.

15. The method of claim 11, further comprising:
determining an expected utilization of the at least one wireless interface at the at least one location along the route, and
determining the estimated transmission bandwidth depending on the expected utilization.

16. The method of claim 11, further comprising:
storing the historical values relating to the wireless interface parameters in the geo-database additionally as a function of at least one environmental parameter of the at least one location, and
also determining the expected transmission bandwidth as a function of current data relating to the at least one environmental parameter.

17. The method of claim 16, wherein the at least one environmental parameter comprises at least one of weather at the at least one location, a traffic volume at the at least one location, and a time of the year.

18. A method for generating a geo-database storing values relating to wireless interface parameters for a plurality of locations, said wireless interface parameters producing a transmission bandwidth of at least one wireless interface at the plurality of locations, the method comprising:
determining current locations of a plurality of mobile terminals;
acquiring with the mobile terminals values relating to the wireless interface parameters; and
storing in the geo-database the acquired values as well as both the current locations at which the mobile terminals were located during acquisition of the values and a time stamp indicating a time when the values were acquired.

19. The method of claim 18, further comprising storing in the geo-database at least one environmental parameter of a current location in addition to at least one of the acquired values.

20. The method of claim 19, wherein the at least one environmental parameter comprises at least one parameter selected from weather at the current location at the time the value was acquired, a measure of traffic volume at the time the current value was acquired, and a season at the time the current value was acquired.

21. A mobile terminal comprising
a mobile communications module configured to exchange data with at least one stationary data network via at least one wireless interface, and
a control device configured to
derive from historical values stored in a geo-database and relating to wireless interface parameters for a plurality of locations and for predetermined points in time a transmission bandwidth of the at least one wireless interface at the plurality of locations;
determine an expected route of the mobile terminal;
determine an estimated time of arrival of the mobile terminal at at least one location along the route;
determine an expected transmission bandwidth at the at least one location along the route for the estimated time of arrival based on the geo-database; and
transmit the data between the mobile terminal and the at least one stationary data network via the at least one wireless interface and regulate at least one data transmission in dependence on the expected transmission bandwidth available along the route.

22. A motor vehicle comprising a mobile terminal according to claim 21.
